(19) United States
(12) Patent Application Publication
(10) Pub. No.: US 2002/0194341 A1
(43) Pub. Date: Dec. 19, 2002

(54) Apparatus and method for selecting closing information and stationery for an electronic mail message based on the intended recipient

(75) Inventor: Bhupesh Gupta, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/881,872

(22) Filed: Jun. 14, 2001

(51) Int. Cl. G06F 15/16

(52) U.S. Cl. 709/227; 709/206

(57) ABSTRACT

An apparatus and method for selecting closing information and stationery for an electronic mail message based on the intended recipient are provided. The apparatus and method allow a user to define closing information and/or stationery for individual recipients, groups of recipients, domain name categories, and the like. In this way, when the user composes a new electronic mail message and enters the electronic mail address of the recipient, the electronic mail program of the present invention automatically determines which closing information and stationery to use with the new electronic mail message. If the user has not designated the closing information and/or stationery for a particular recipient, a default closing information and/or stationery may be used instead. Likewise, if there are a plurality of recipients having different closing information and/or stationery settings, a default closing information and/or stationery setting may be used. Alternatively, if there are a plurality of recipients, each recipient may receive a different version of the electronic mail message having the same composed content but different closing information and/or stationery.

### BACKGROUND OF THE INVENTION

1. Technical Field

The present invention is directed to an improved computing device. More specifically, the present invention is directed to an apparatus and method for selecting closing information and stationery for an electronic mail message based on the intended recipient.

2. Description of Related Art

Electronic mail programs are fast becoming a primary mode of communication between people using data networks. There are various types of electronic mail programs including Lotus Notes™, Microsoft Outlook™, WinPop™, and the like. Each of these electronic mail programs offer the same basic functionality—the ability to send and receive electronic mail messages to other individuals having electronic mail addresses.

In some of these electronic mail programs, a functionality is provided that allows a composer of an electronic mail message to define closing information and select a stationery to be used with the electronic mail message. The closing information may include a text message and/or graphic that is appended to the end of the electronic mail message when the electronic mail message is composed and/or sent. The stationery is basically a graphical background on which the electronic mail message is superimposed.

While the prior art electronic mail programs allows a composer to input closing information and select a stationery to be used, the closing information and stationery are global variables. That is, the closing information and stationery used for all electronic mail messages is the same until the composer redefines the closing information and stationery. Thus, if the composer of the electronic mail messages wants to use a different closing and/or stationery for the electronic mail messages, he/she must redefine the closing information and select a different stationery for each electronic mail message. There is no ability for defining different closing information and/or stationery for different types of electronic mail messages and have the electronic mail program determine which closing information and/or stationery to use for these different types of electronic mail messages.

### SUMMARY OF THE INVENTION

The present invention provides an apparatus and method for selecting closing information and stationery for an electronic mail message based on the intended recipient. The present invention allows a user, or electronic mail message composer, to define closing information and/or stationery for individual recipients, groups of recipients, domain name categories, and the like. In this way, when the user composes a new electronic mail message and enters the electronic mail address of the recipient, the electronic mail program of the present invention automatically determines which closing information and stationery to use with the new electronic mail message.

If the user has not designated the closing information and/or stationery for a particular recipient, a default closing information and/or stationery may be used instead. Likewise, if there are a plurality of recipients having different closing information and/or stationery settings, a default closing information and/or stationery setting may be used. Alternatively, if there are a plurality of recipients, each recipient may receive a different version of the electronic mail message having the same composed content but different closing information and/or stationery. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a distributed data processing system in accordance with the present invention;

FIG. 2 is an exemplary diagram illustrating a server data processing device in accordance with the present invention;

FIG. 3 is an exemplary diagram illustrating a client data processing device in accordance with the present invention;

FIG. 4 is an exemplary block diagram of the primary operational components of the present invention;

FIG. 5 is an exemplary diagram of an electronic mail program interface for adding a new contact and designating closing information and a stationery for the new contact in accordance with the present invention;

FIG. 6 is an exemplary diagram of an electronic mail program interface for adding a new group of contacts and designating closing information and a stationery for the group of contacts in accordance with the present invention;

FIG. 7 is an exemplary diagram of an electronic mail program interface for adding a new domain name category and designating closing information and a stationery for the domain name category in accordance with the present invention;

FIG. 8 is an exemplary diagram of an electronic mail program interface in which new electronic mail message closing information may be created in accordance with the present invention;

FIG. 9 is an exemplary diagram of an electronic mail program interface in which new electronic mail message stationery may be created in accordance with the present invention; and

FIG. 10 is a flowchart outlining an exemplary operation of the present invention when determining which closing information and stationery to use with an outgoing electronic mail message.

### DETAILED DESCRIPTION OF THE PREFERRED EMBODIMENT

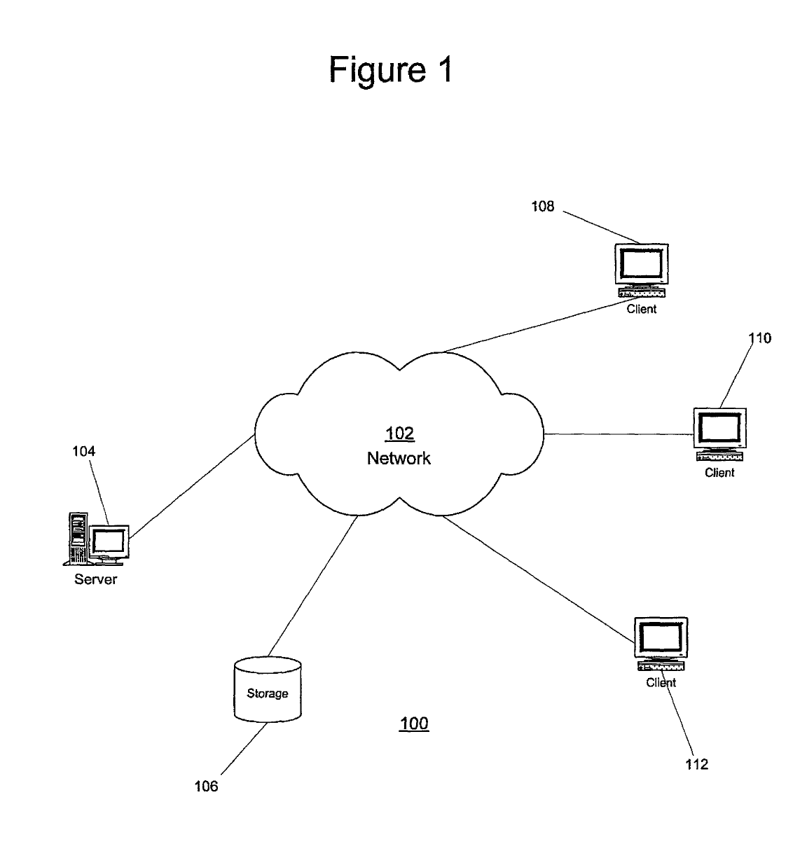

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Each of the client devices 108-112 are equipped with an electronic mail program according to the present invention. The server 104 acts as an electronic mail server through which electronic mail communication between the client devices 108-112 is facilitated in a known manner. The users of the client devices 108-112 may make use of the functionality of the present invention, implemented as software instructions in the electronic mail programs of the client devices 108-112, to designate closing information and/or stationery for various recipients, groups of recipients, domain names, and the like.

While in the preferred embodiment the present invention is implemented as software instructions that are incorporated as part of an electronic mail program in client devices, the present invention is not limited to such an embodiment. Rather, the present invention may be implemented in a central server that is accessible by users via client devices and a data network. Moreover, the present invention may be implemented in software, hardware, or a combination of software and hardware.

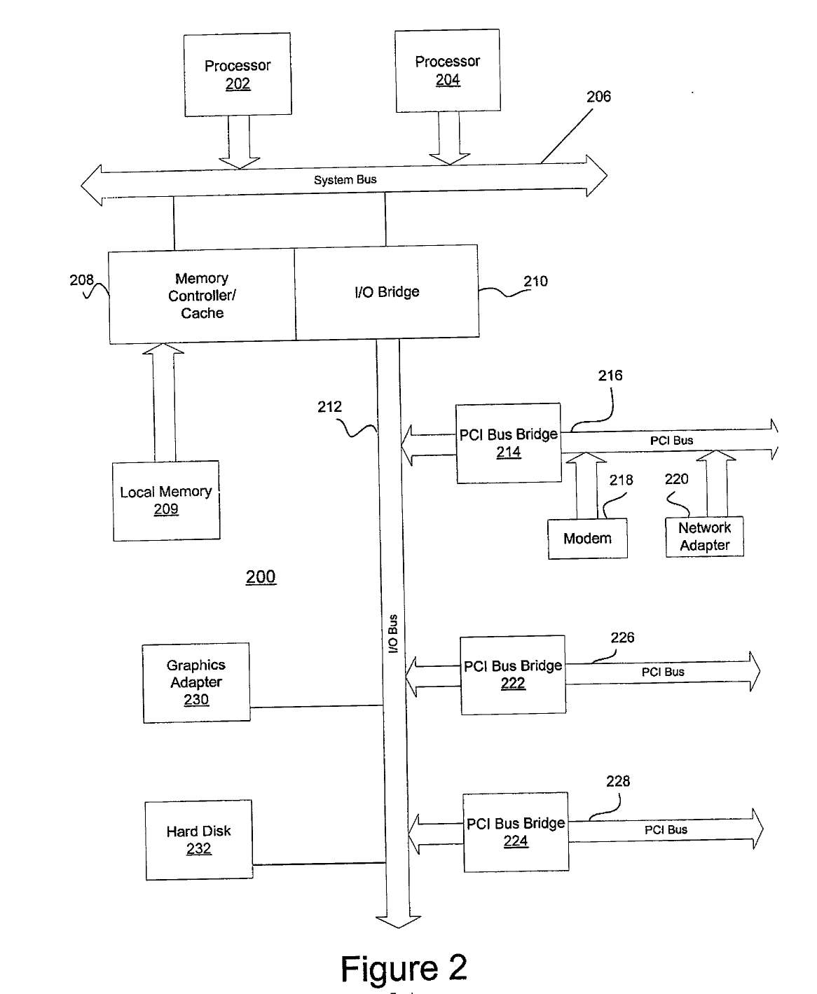

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y. running the Advanced Interactive Executive (AIX) operating system or LINUX operating system.

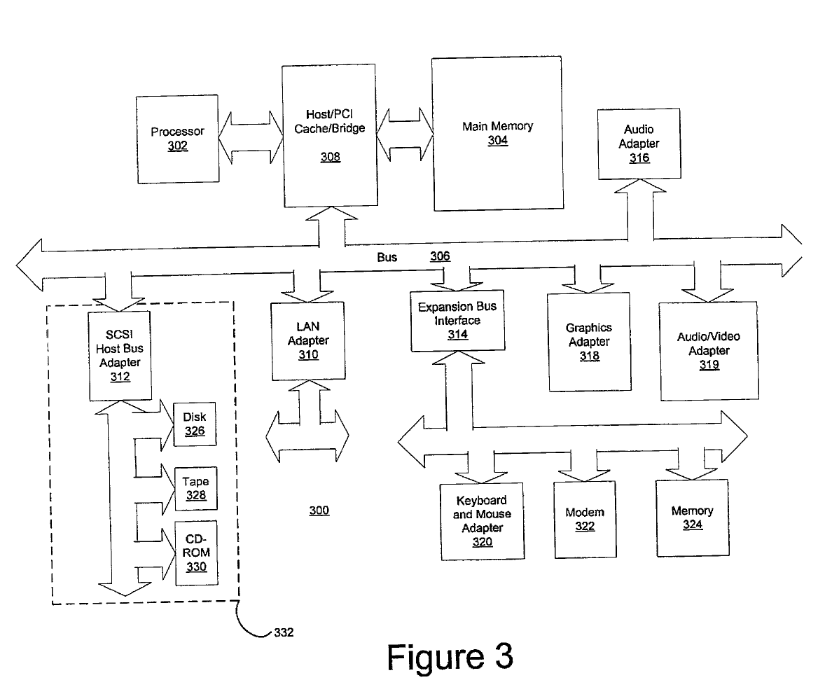

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides a mechanism through which users may designated closing information and/or stationery for various recipients, groups of recipients, domain names, and the like. In so doing, the present invention may automatically append appropriate closing information and stationery to an outgoing electronic mail message based on the intended recipient(s) of the electronic mail message.

The user of the present invention may designate various closing information that may be used with electronic mail messages. The present invention provides an interface through which the user may insert text of the closing information and designate files representing graphics to be added to the closing information. This closing information may then be stored in a data structure associated with the electronic mail program. The registry of available closing information may then be updated to include an identifier of the new closing information. In this way, the new closing information will be included as an optional closing information when new contacts, groups of contacts, domain names, and the like are defined by the user.

With the present invention, a user may add a new contact to his/her electronic mail address book using an electronic mail program interface. In adding the new contact, the user may designate the electronic mail address of the new contact, a stationery to be used with electronic mail messages sent to the new contact, closing information to be appended to the end of electronic mail messages sent to the new contact, whether or not spell check should be performed on electronic mail messages to the new contact, and the like. The selected settings of these various parameters for the new contact may then be stored in a data structure associated with the electronic mail program. In this way, electronic mail message recipient profiles may be generated and stored for later use in composing and transmitting electronic mail messages to these recipients.

In addition to adding individual recipients by adding a new contact, the present invention further provides an ability to define groups of contacts. Each group of contacts may further have specific stationery, closing information, spell check options, and the like, designated for the group. This information may be stored in a data structure associated with the electronic mail program.

Thus, for example, if an electronic mail message is composed and the recipient is designated to be the group “Family and Friends,” all recipients in the group “Family and Friends” will receive the electronic mail message formatted in the same manner. In this way, if a group is selected as a recipient of an electronic mail message, each recipient in the group will receive an electronic mail message formatted according to the group specifications.

Moreover, the present invention provides an ability to designate domain names and associated electronic mail message formats, i.e. closing information, stationery, whether to use spell check, and the like. This information may also be stored in a data structure associated with the electronic mail program.

Thus, a user may designate that all electronic mail messages sent to contacts having the domain name “ibm.com” in their electronic mail address will have a designated format. Thus, for example, if electronic mail messages are sent to steve@ibm.com and joe@ibm.com, both of these messages will have the same closing information and/or stationery, spell check options, and the like, because they both have the domain name “ibm.com”.

In addition to selecting the parameters of closing information, stationery and whether to use spell check or not, the present invention may provide a user with any number of other parameters that may be set for various recipients, groups of recipients, domain names and the like. For example, the present invention may allow a user to designate the type of font, the color of the font, the size of the font, spacing between lines of text, and the like, to be used with electronic mail messages sent to various recipients. The selection of such parameters may be made when defining the new closing information and stationery or may be made as a selection of parameters outside that of the new closing information and stationery. In so doing, rather than having all electronic mail messages use the same settings, the electronic mail messages may be customized based on the intended recipient(s).

With the present invention, when a user composes an electronic mail message, the user typically enters one or more recipient electronic mail addresses (such as steve@ibm.com), or contact identifiers (such as “Steve” which is then correlated to “steve@ibm.com” using the address book in a manner generally known in the art), enters a text body for the electronic mail message, and designates any desired attachments to the electronic mail message. Based on the one or more recipient electronic mail addresses entered, the present invention performs a look-up of the electronic mail address in the data structures associated with the electronic mail program.

The look-up of the electronic mail address may be performed based on the number of recipients identified in the electronic mail message. For example, if there are a plurality of recipients, the look-up may first determine if the recipients are part of a defined group of recipients. If so, the group settings may be used to format the electronic mail address. If the recipients are not part of a defined group, it may be determined whether the recipients have a same domain name in their electronic mail addresses.

If the recipients have the same domain name, a look-up of the domain name may be performed with the associated data structures. If the domain name is found, the associated settings may be used to format the electronic mail message. If the domain name is not found, a default format may be utilized.

If the recipients have different domain names and are not part of a defined group, each recipient may be looked-up to identify associated settings. If the recipient is found in the associated data structures, the recipient's settings are retrieved and compared to the other recipients' settings. If a recipient is not found in the associated data structure, the default settings may be retrieved for this recipient.

The settings are then compared to determine if they are compatible. That is, a determination is made as to whether the settings for the recipients include the same closing information, same stationery, same font, same font color, etc. Some parameters may be compatible even if they are not the same among various recipients. For example, if any one of the recipients has the spell check option enabled and other ones of the recipients do not have this option enabled, rather than holding the recipient settings as incompatible, the present invention may enable the spell check option for all of the recipients.

This same ability may be applied to font type, font color, and the like. For example, if a majority of the recipients make use of a particular font type or font color, the font type or font color of the electronic mail message for all recipients may be set to this font type and font color. Alternatively, strict compatibility may be required and thus, any difference in the settings for the recipients will result in incompatibility of the settings.

It should be noted that a recipient may be an individual recipient, a member of a defined domain name group, and a member of a defined group of recipients. As such, one recipient may have a plurality of different groups of settings. The present invention may retrieve each of these groups of settings and compare them to each of the groups of settings of the other designated recipients to determine if any combination of groups are identical. That is, the domain name group settings for a first recipient may match the defined group settings of another recipient and thus, this matching group of settings, i.e. this compatible group of settings, will be utilized to format the electronic mail message.

If the recipient settings are not compatible, a default setting may be used to format the electronic mail message. In an alternative embodiment, if the recipient settings are not compatible, each recipient receives a copy of the electronic mail message that is formatted to his/her specific settings. Thus, each recipient receives a different version of the electronic mail message with the subject matter of the electronic mail message being identical but the format being different. Prior to actual sending of the different versions of the electronic mail message, the composer of the electronic mail message may be provided with the opportunity to review each version in order to determine whether each version meets with the composer's approval.

If the recipient settings are compatible, or if only a single recipient is designated, the settings are used to format the electronic mail message prior to sending the electronic mail message to the recipient(s). Such formatting may include appending the designated closing information, changing the stationery on which the electronic mail message is superimposed, changing the font of the electronic mail message, changing the color of the font, and the like. The formatting of the electronic mail message based on these settings may be performed prior to the user initiating the transmission of the electronic mail message or may be performed in response to the user initiating the transmission of the electronic mail message.

If performed prior to transmission, the user may be provided with an option to review the reformatted electronic mail message prior to transmission.

The functions of the present invention outlined above may be performed whenever an electronic mail message is being sent to a recipient. This may include generating a new electronic mail message or replying to a received electronic mail message. In either case, the operations of the present invention will be performed to thereby, automatically format the electronic mail message according to the defined settings for the recipients.

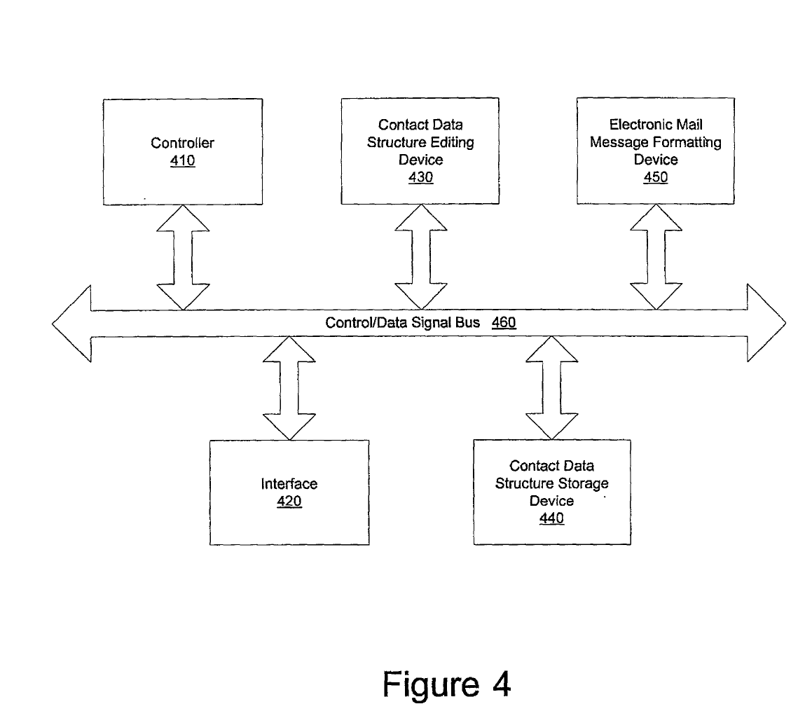

FIG. 4 is an exemplary block diagram illustrating the primary operational components of the present invention. The operational components shown in FIG. 4 may be implemented in software, hardware, or a combination of software and hardware without departing from the spirit and scope of the present invention.

As shown in FIG. 4, the customized electronic mail apparatus of the present invention includes a controller 410, an interface 420, a contact data structure editing device 430, a contact data structure storage device 440, and an electronic mail message formatting device 450. The components 410-450 are coupled to one another via the control/data signal bus 460. Although a bus architecture is shown in FIG. 4, the present invention is not limited to such and any mechanism for facilitating the exchange of control and/or data signals between the components 410-450 may be used without departing from the spirit and scope of the present invention.

The controller 410 controls the overall operation of the customized electronic mail apparatus and orchestrates the operation of the other components 420-450. The controller 410 provides the primary electronic mail program interfaces to the client device via the interface 420, either directly or through a data network, and receives input from the user of the client device via the interface 420.

The contact data structure editing device 430 operates in response to a user input to edit available contact information, create a new contact, or edit the settings of an existing contact. The contact data structure editing device 430 operates to provide the user of the client device with various electronic mail program interfaces for defining new closing information, new contact information and settings, and edit existing contact information and settings.

The contact data structure storage device 440 stores the contact information and settings in a data structure that is searchable by the present invention. When a new electronic mail message is being generated, or a reply to a received electronic mail message is being generate, the electronic mail message formatting device 450 receives the electronic mail addresses of the intended recipients and performs a look-up of these recipient addresses using the data structure(s) in the contact data structure storage device 440 in the manner previously described. The electronic mail message formatting device 450 then resolves any discrepancies between the settings of the recipients, as discussed above, and reformats the electronic mail message prior to transmitting it to the recipients. The reformatted electronic mail message is then transmitted by the controller 410 to the designated recipients via the interface 420, or other network interface (not shown).

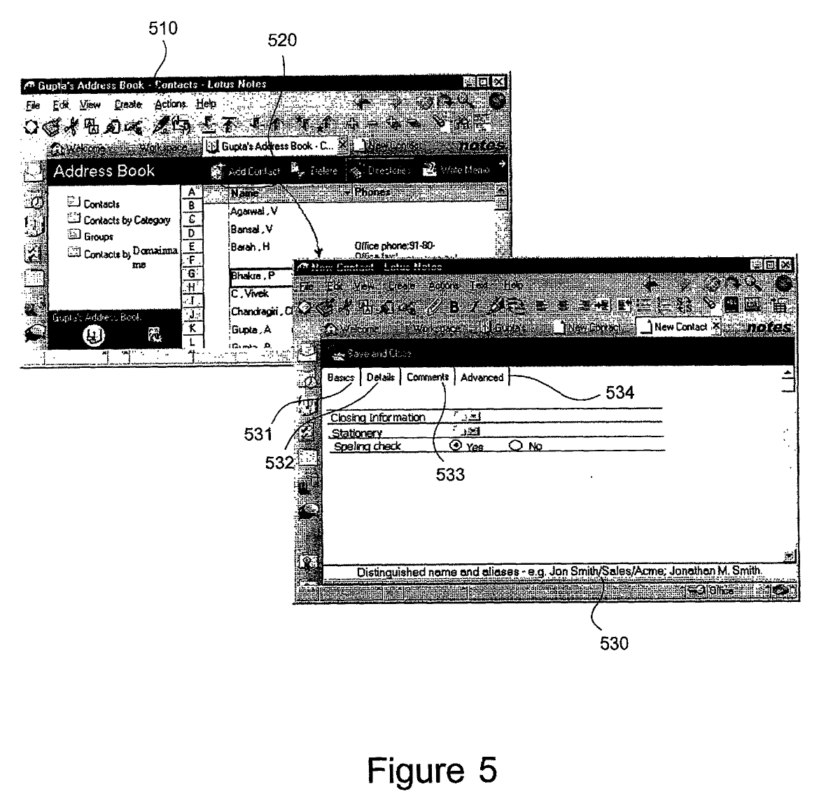

FIG. 5 is an exemplary diagram illustrating an electronic mail program interface for adding a new contact according to the present invention. As shown in FIG. 5, the primary electronic mail program interface 510 includes a virtual button 520 that is selectable by a user, via a pointing device, to thereby initiate an operation to add a new contact to the contact data structure. When the virtual button 520 is selected, a subsequent electronic mail program interface 530 is presented having various tabs 531-534. The tabs provide various options that may be selected by the user, in a manner that is generally known in the art.

One tab includes selectable options through which the user may designate the closing information, stationery, whether to use spell check, and the like, with electronic mail messages set to this contact. To select the closing information and stationery, the user need only select the virtual “down arrow” button to receive a listing of the possible closing messages and stationeries. This listing may include a “none” option as well as a “default” option in addition to customized options that have been defined by the user. Moreover, the listing may further include an option to generate new closing information for this contact, as will be discussed in greater detail hereafter.

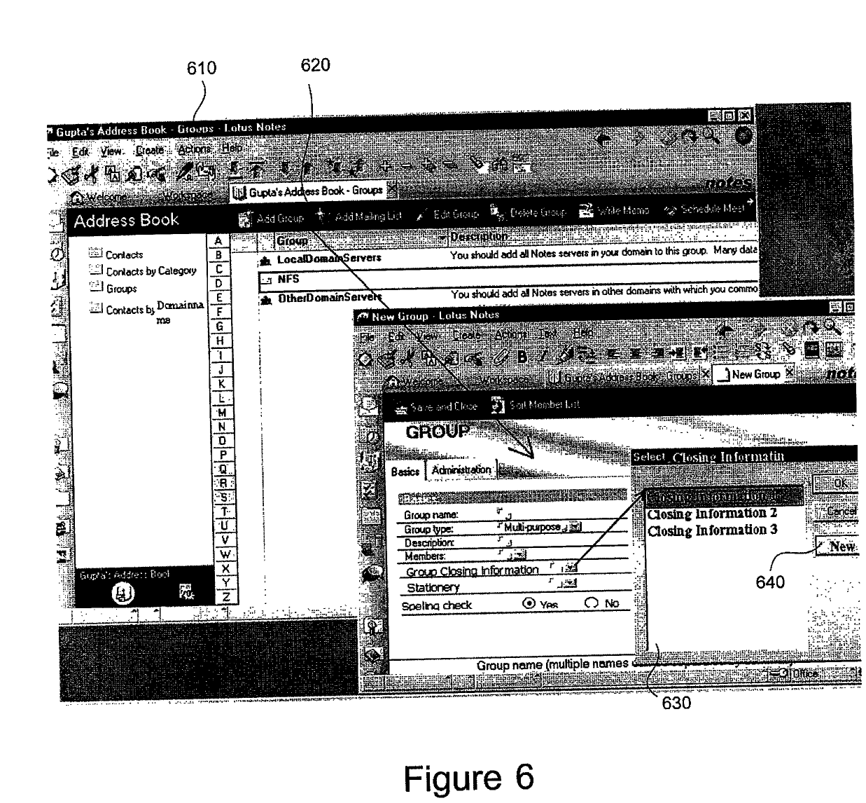

FIG. 6 is an exemplary diagram of an electronic mail program interface for defining a group of contacts or recipients. As shown in FIG. 6, the primary electronic mail program interface 610 may include a virtual button 620 for adding a new group to the contact data structure. In response to selection of the virtual button 620, a new electronic mail program interface 630 is presented to the user providing him/her with the ability to designate the attributes of a new group of contacts or recipients. As shown in FIG. 6, this new electronic mail program interface 630 includes fields for designating the name of the group, the group type, a description of the group, the members of the group, closing information to be used with this group, stationery to be used with this group, whether to use spell check with this group, and the like.

FIG. 6 further illustrates the drop down menu that is provided with the “down arrow” virtual button is selected to thereby obtain a listing of possible closing information. As shown in FIG. 6, this drop down menu includes a listing of the available closing information as well as a virtual button 640 for initiating the definition of new closing information.

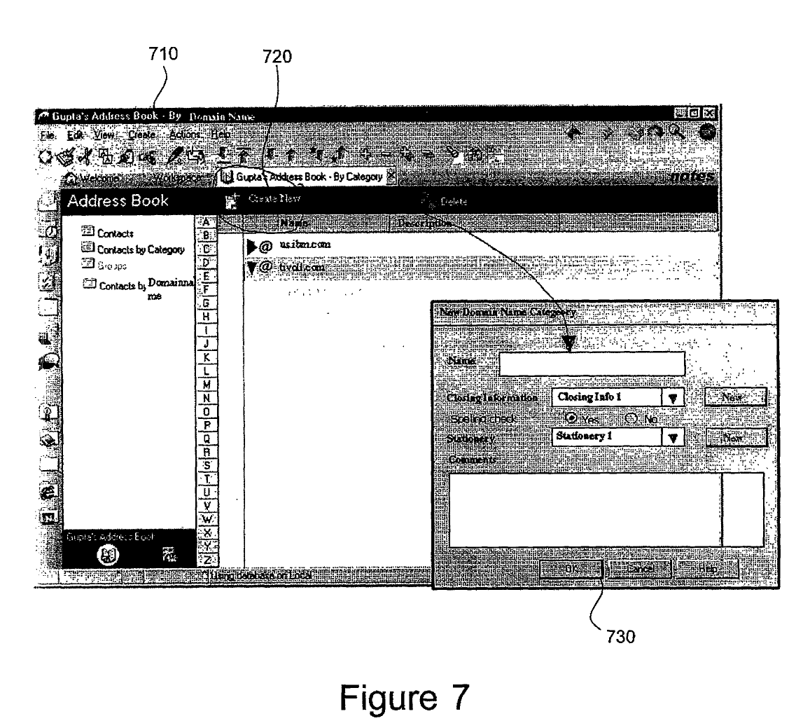

FIG. 7 is an exemplary diagram illustrating an electronic mail program interface for defining a new domain name category. As shown in FIG. 7, the primary electronic mail program interface 710 may include a virtual button 720 that is selectable to initiate a function for defining a new domain name category. When the virtual button 720 is selected, a new electronic mail program interface 730 is provided to the user through which the user may define the new domain name category. The new electronic mail program interface 730 may include a field for entering the domain name, a field for selecting closing information for this domain name, a field for selecting the stationery for this domain name, a field for selecting whether to use spell check for this domain name, and the like. Moreover, when the “down arrow” virtual buttons are selected, a drop down menu listing of available selections is provided similar to that shown in FIG. 6.

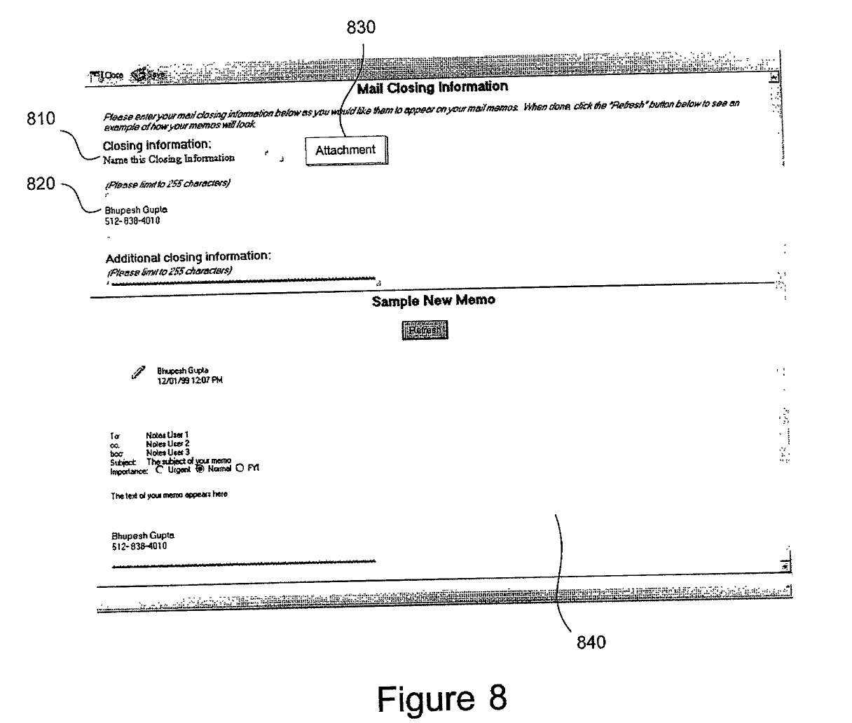

As mentioned previously, the listing of possible selections of closing information may include an option for defining new closing information for electronic mail recipients. FIG. 8 is an exemplary diagram illustrating an electronic mail program interface for defining new closing information for an electronic mail. As shown in FIG. 8, the interface includes a field 810 for designating a name of the closing information, one or more fields 820 for inputting the text of the closing information, a virtual button 830 for initiating the attachment of a graphic file to the closing information, and a sample view portion 840 for viewing a sample of the closing information. Using this interface, the user may input a name for the closing information, the text for the closing information, a graphic to be included (if desired), and see the resulting closing information prior to saving it for use with subsequent electronic mail messages.

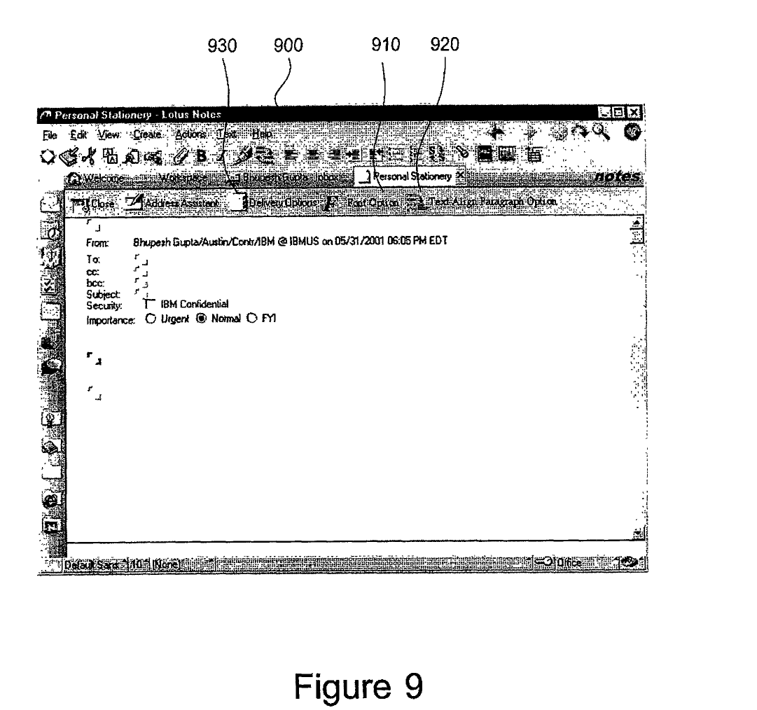

FIG. 9 is an exemplary diagram illustrating an electronic mail program interface for defining new stationery. As shown in FIG. 9, the electronic mail program interface 900 includes options to set font type 910, paragraph style 920 and delivery options 930. In addition, the electronic mail program interface 900 may be modified to provide the options to add a water mark, background figure, and the like, to the new stationery.

The electronic mail program interfaces shown in FIGS. 5-9 are used to define the closing information, stationery, spell check option, and the like, for one or more recipients, groups of recipients, domain name categories, and the like. Once these settings are designated, they may be used to customize electronic mail messages based on the intended recipients of the electronic mail message. The present invention includes functionality for automatically determining a format for the electronic mail message based on the designated intended recipient(s).

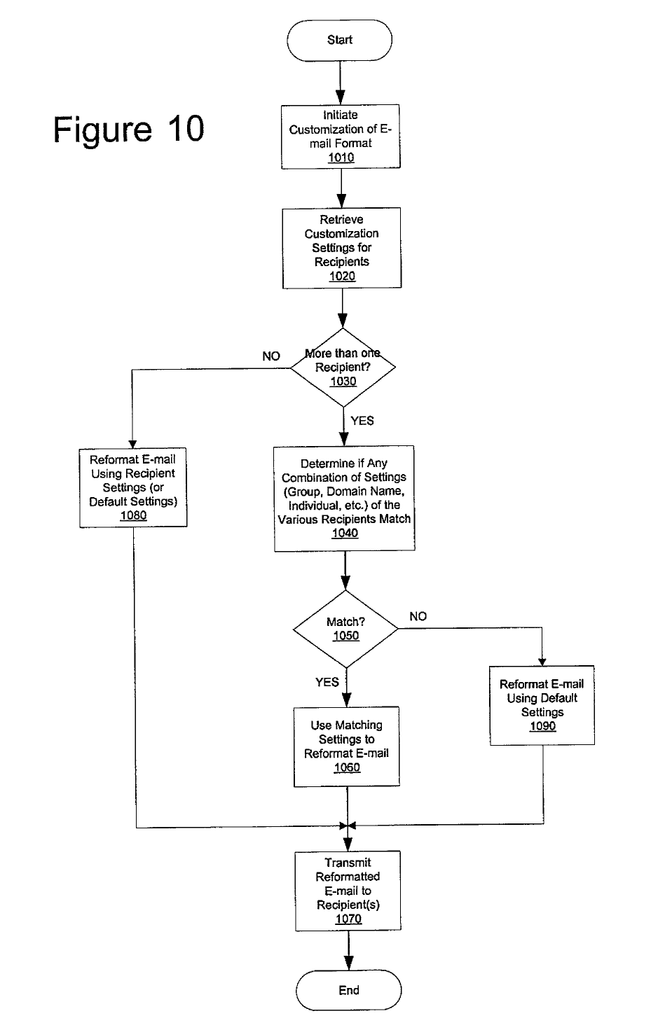

FIG. 10 is a flowchart outlining an operation of the present invention when determining what electronic mail message format settings to use with an outgoing electronic mail message. As shown in FIG. 10, the operation starts with an initiation of the customization function of the present invention (step 1010). Customization settings for the recipients designated in the electronic mail message are retrieved (step 1020). Such retrieval may include retrieving customization settings for the individual recipients, groups to which the recipients belong, domain names of the electronic mail addresses of the recipients, and the like. If customization settings are not stored for a particular recipient, default customization settings may be used.

A determination is then made as to whether there is more than one recipient designated for the electronic mail message (step 1030). If not, the customization settings for the recipient (or default settings depending on the circumstances) are used to reformat the electronic mail message (step 1080). If there is more than one recipient designated, a determination is made as to whether any combination of settings for the recipients results in a match of the settings (step 1040).

If there is a match (step 1050), the matching settings are used to reformat the electronic mail message for all of the recipients (step 1060). If there is not a match (step 1050), the electronic mail message is reformatted using default settings (step 1090). In an alternative embodiment, rather than determining if there is a match and reformatting using the matching settings, each individual recipient may receive a separate copy of the electronic mail message that is reformatted to his/her specific settings.

Once the electronic mail message is reformatted according to the appropriate customization settings (if any), the reformatted electronic mail message is transmitted to the designated recipient(s) (step 1070) and the operation ends. In this way, a user may designate different electronic mail message formats for different individual recipients, groups of recipients, domain names of recipients, and the like. The result is an electronic mail program that is capable of automatically reformatting electronic mail messages based on previously defined customization settings for intended recipients. The electronic mail program of the present invention is more versatile than the prior art electronic mail programs that require that all electronic mail messages use the same format until the “global” format is changed by the user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of formatting an electronic mail message, comprising:
storing one or more recipient profiles, wherein the one or more recipient profiles identify an electronic mail message format for a corresponding recipient;
identifying a recipient of an electronic mail message; and
formatting the electronic mail message based on a recipient profile corresponding to the identified recipient.

2. The method of claim 1, wherein the one or more recipient profiles include a recipient group format setting corresponding to a plurality of recipients, and wherein the recipient group format setting identifies electronic mail format settings that are common to the plurality of recipients.

3. The method of claim 1, wherein the one or more recipient profiles include a domain name category format setting corresponding to a plurality of recipients, and wherein the domain name category format setting identifies electronic mail format settings that are common to the plurality of recipients.

4. The method of claim 1, wherein the electronic mail message is directed to a plurality of designated recipients, and wherein formatting the electronic mail message includes identifying a set of compatible electronic mail format settings from among the electronic mail format settings of the designated recipients.

5. The method of claim 4, wherein if a set of compatible electronic mail format settings cannot be identified from among the electronic mail format settings of the designated recipients, a default set of electronic mail format settings is used to format the electronic mail message.

6. The method of claim 4, wherein the electronic mail format settings include at least one of closing information, stationery, whether to use spell check, a font, a font color, a font size, and a line spacing.

7. The method of claim 1, wherein the electronic mail message is directed to a plurality of designated recipients, and wherein the electronic mail message is replicated into a different version of the electronic mail message for each of the plurality of designated recipients based on the one or more recipient profiles such that the content of each version of the electronic mail message is the same but the format is specific to the electronic mail format of a corresponding recipient profile.

8. The method of claim 7, wherein the electronic mail message is replicated in response to a user entering a command to transmit the electronic mail message.

9. The method of claim 7, wherein the electronic mail message is replicated in response to a command entered by a user, and wherein the user may review the versions of the electronic mail message prior to transmitting them.

10. The method of claim 1, wherein the electronic mail message is directed to more than one designated recipient, and wherein formatting the electronic mail message includes identifying a common set of electronic mail format settings for the more than one designated recipient, and wherein identifying a common set of electronic mail format settings includes:
identifying at least one of a group set of electronic mail format settings, a domain name category set of electronic mail format settings, and an individual set of electronic mail format settings for each of the at least one designated recipient;
comparing each set of electronic mail format settings of each of the at least one designated recipient to each set of electronic mail format settings of each other recipient of the at least one designated recipient to identify matching sets of electronic mail format settings; and
using the matching sets of electronic mail format settings to reformat the electronic mail message.

11. A method of customizing an electronic mail message based on settings for an intended recipient, comprising:
receiving an electronic mail message;
identifying at least one recipient of the electronic mail message;
identifying at least one electronic mail message format for the at least one recipient; and
reformatting the electronic mail message based on the at least one electronic mail message format.

12. The method of claim 11, wherein the at least one recipient is categorized into a recipient group, and wherein the recipient group has electronic mail format settings that are common to all of the recipients in the recipient group.

13. The method of claim 11, wherein the at least one recipient is categorized into a domain name category, and wherein the domain name category has electronic mail format settings that are common to all of the recipients in the domain name category.

14. The method of claim 11, wherein the electronic mail message is directed to a plurality of recipients, and wherein reformatting the electronic mail message includes identifying a set of compatible electronic mail message format settings from among the electronic mail message format settings of the plurality of recipients.

15. The method of claim 14, wherein if a set of compatible electronic mail message format settings cannot be identified from among the electronic mail message format settings of the designated recipients, a default set of electronic mail message format settings is used to reformat the electronic mail message.

16. The method of claim 11, wherein the electronic mail message format settings include at least one of closing information, stationery, whether to use spell check, a font, a font color, a font size, and a line spacing.

17. The method of claim 11, wherein the electronic mail message is directed to a plurality of recipients, and wherein the electronic mail message is replicated into a different version of the electronic mail message for each of the plurality of recipients based on the electronic mail message format settings for each of the plurality of recipients such that the content of each version of the electronic mail message is the same but the format is specific to the electronic mail message format settings of a corresponding one of the plurality of recipients.

18. The method of claim 17, wherein the electronic mail message is replicated in response to a user entering a command to transmit the electronic mail message.

19. The method of claim 17, wherein the electronic mail message is replicated in response to a command entered by a user, and wherein the user may review the versions of the electronic mail message prior to transmitting them.

20. The method of claim 11, wherein reformatting the electronic mail message includes identifying a common set of electronic mail message format settings for the at least one designated recipient, and wherein identifying a common set of electronic mail message format settings includes:
identifying at least one of a group set of electronic mail message format settings, a domain name category set of electronic mail message format settings, and an individual set of electronic mail message format settings for each of the at least one recipient;
comparing each set of electronic mail message format settings of each of the at least one recipient to each set of electronic mail message format settings of each other recipient of the at least one recipient to identify matching sets of electronic mail message format settings; and
using the matching sets of electronic mail message format settings to reformat the electronic mail message.

21. A method of customizing an electronic mail message based on settings for an intended recipient, comprising:
storing electronic mail format settings for a plurality of possible recipients, the electronic mail format settings designating an electronic mail format for a recipient that is different from an electronic mail format of another recipient;
generating an electronic mail message for at least one designated recipient of the plurality of possible recipients; and
customizing the electronic mail message according to the electronic mail format settings for the recipient.

22. An apparatus for customizing an electronic mail message based on settings for an intended recipient, comprising:
an interface that receives an electronic mail message; and
an electronic mail message formatting device coupled to the interface that identifies at least one recipient of the electronic mail message, identifies at least one electronic mail message format for the at least one recipient, and reformats the electronic mail message based on the at least one electronic mail message format.

23. The apparatus of claim 22, wherein the at least one recipient is categorized into a recipient group, and wherein the recipient group has electronic mail format settings that are common to all of the recipients in the recipient group.

24. The apparatus of claim 22, wherein the at least one recipient is categorized into a domain name category, and wherein the domain name category has electronic mail format settings that are common to all of the recipients in the domain name category.

25. The apparatus of claim 22, wherein the electronic mail message is directed to a plurality of recipients, and wherein the electronic mail message formatting device reformats the electronic mail message by identifying a set of compatible electronic mail message format settings from among the electronic mail message format settings of the plurality of recipients.

26. The apparatus of claim 25, wherein if a set of compatible electronic mail message format settings cannot be identified from among the electronic mail message format settings of the designated recipients, the electronic mail message formatting device uses a default set of electronic mail message format settings to reformat the electronic mail message.

27. The apparatus of claim 22, wherein the electronic mail message format settings include at least one of closing information, stationery, whether to use spell check, a font, a font color, a font size, and a line spacing.

28. The apparatus of claim 22, wherein the electronic mail message is directed to a plurality of recipients, and wherein the electronic mail message formatting device replicates the electronic mail message into a different version of the electronic mail message for each of the plurality of recipients based on the electronic mail message format settings for each of the plurality of recipients such that the content of each version of the electronic mail message is the same but the format is specific to the electronic mail message format settings of a corresponding one of the plurality of recipients.

29. The apparatus of claim 28, wherein the electronic mail message is replicated in response to a user entering a command to transmit the electronic mail message.

30. The apparatus of claim 28, wherein the electronic mail message is replicated in response to a command entered by a user, and wherein the user may review the versions of the electronic mail message prior to transmitting them.

31. The apparatus of claim 22, wherein the electronic mail message formatting device reformats the electronic mail message by identifying a common set of electronic mail message format settings for the at least one recipient, and wherein the electronic mail message formatting device identifies a common set of electronic mail message format settings by:
identifying at least one of a group set of electronic mail message format settings, a domain name category set of electronic mail message format settings, and an individual set of electronic mail message format settings for each of the at least one recipient;
comparing each set of electronic mail message format settings of each of the at least one recipient to each set of electronic mail message format settings of each other recipient of the at least one recipient to identify matching sets of electronic mail message format settings; and
using the matching sets of electronic mail message format settings to reformat the electronic mail message.

32. A computer program product in a computer readable medium for customizing an electronic mail message based on settings for an intended recipient, comprising:
first instructions for receiving an electronic mail message;
second instructions for identifying at least one recipient of the electronic mail message;
third instructions for identifying at least one electronic mail message format for the at least one recipient; and
fourth instructions for reformatting the electronic mail message based on the at least one electronic mail message format.

33. The computer program product of claim 32, wherein the at least one recipient is categorized into a recipient group, and wherein the recipient group has electronic mail format settings that are common to all of the recipients in the recipient group.

34. The computer program product of claim 32, wherein the at least one recipient is categorized into a domain name category, and wherein the domain name category has electronic mail format settings that are common to all of the recipients in the domain name category.

35. The computer program product of claim 32, wherein the electronic mail message is directed to a plurality of recipients, and wherein the fourth instructions for reformatting the electronic mail message include instructions for identifying a set of compatible electronic mail message format settings from among the electronic mail message format settings of the plurality of recipients.

36. The computer program product of claim 35, wherein the fourth instructions further include instructions for using a default set of electronic mail message format settings to reformat the electronic mail message if a set of compatible electronic mail message format settings cannot be identified from among the electronic mail message format settings of the designated recipients.

37. The computer program product of claim 32, wherein the electronic mail message format settings include at least one of closing information, stationery, whether to use spell check, a font, a font color, a font size, and a line spacing.

38. The computer program product of claim 32, wherein the electronic mail message is directed to a plurality of recipients, and wherein the fourth instructions for reformatting the electronic mail message includes instructions for replicating the electronic mail message into a different version of the electronic mail message for each of the plurality of recipients based on the electronic mail message format settings for each of the plurality of recipients such that the content of each version of the electronic mail message is the same but the format is specific to the electronic mail message format settings of a corresponding one of the plurality of recipients.

39. The computer program product of claim 38, wherein the electronic mail message is replicated in response to a user entering a command to transmit the electronic mail message.

40. The computer program product of claim 38, wherein the electronic mail message is replicated in response to a command entered by a user, and wherein the user may review the versions of the electronic mail message prior to transmitting them.

41. The computer program product of claim 32, wherein the fourth instructions for reformatting the electronic mail message include instructions for identifying a common set of electronic mail message format settings for the at least one designated recipient, and wherein the instructions for identifying a common set of electronic mail message format settings include:
instructions for identifying at least one of a group set of electronic mail message format settings, a domain name category set of electronic mail message format settings, and an individual set of electronic mail message format settings for each of the at least one recipient;
instructions for comparing each set of electronic mail message format settings of each of the at least one recipient to each set of electronic mail message format settings of each other recipient of the at least one recipient to identify matching sets of electronic mail message format settings; and
instructions for using the matching sets of electronic mail message format settings to reformat the electronic mail message.
